(19) United States
(12) Patent Application Publication
(10) Pub. No.: US 2009/0248575 A1
(43) Pub. Date: Oct. 1, 2009

(54) AUTOMATIC SUBSCRIPTION TO PAY CONTENT

(75) Inventors: Adolf J. Dipl. Ing. Proidl, Vessem (NL); Srinivas Gutta, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,224

(22) PCT Filed: Dec. 8, 2005
(86) PCT No.: PCT/IB05/54137

§ 371 Date: Jun. 8, 2007

Related U.S. Application Data
(60) Provisional application No. 60/635,393, filed on Dec. 10, 2004.

(51) Int. Cl. G06Q 30/00

(52) U.S. Cl. 705/40; 705/1

(57) ABSTRACT

A system to autonomously authorize billing for a subscription plan for a user using data including available subscription services, a user profile, and a user supplied criteria for subscription service selection such as a spending limit related to the available subscription services. In one embodiment, the present invention may rate the available subscription services in accordance with the user profile and may then select a given number of high rated subscription services for the subscription plan. The user profile may be updated to reflect changes in a user's preference. The subscribed content may be provided to the user as a personal television channel.

The present invention relates to a system and method for subscribing to pay content based on a customer's preference or profile.

In the present day, a user of a content delivery system is typically provided with a huge amount of content that is available and varied delivery options that give the user a tremendous variety and range of choices. For example, a user of a display viewing system such as a television is typically provided with cable channels, satellite television channels, and Internet channels that each may deliver hundreds of different channels with various different program content. Currently, over 500 different program channels are available through some cable television services alone. For subscription services such as satellite, cable TV, and Internet, viewers are also provided with different payment options even within a given service for varying portions of the program content that is available.

For example, viewers may be charged per program that they watch or a monthly flat rate for all programs in a particular channel or a group of channels. However, viewers must weigh the options available to them and decide which of the multitude of available services is desired. Oftentimes, these decisions are rendered without the user even having a clear idea of all of the different options that are available.

Accordingly, it is an object of the present invention to overcome these disadvantages and/or others of the prior art.

The present invention autonomously authorizes billing for a subscription plan for a user. The invention uses data including available subscription services, a user profile, and a user supplied criteria for subscription service selection such as a spending limit related to the available subscription services. In one embodiment, the present invention may rate the available subscription services in accordance with the user profile and may then select a given number of high rated subscription services for the subscription plan. The user profile may be updated to reflect changes in a user's preference. The subscribed content may be provided to the user as a personal television channel.

The following are descriptions of illustrative embodiments of the present invention that when taken in conjunction with the following drawings will demonstrate the above noted features and advantages, as well as further ones. In the following description, for purposes of explanation rather than limitation, specific details are set forth such as the particular architecture, interfaces, techniques, etc., to provide an illustration of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention. In the figures, like parts of the system are denoted with like numbers.

The invention is best understood in conjunction with the accompanying drawings in which:

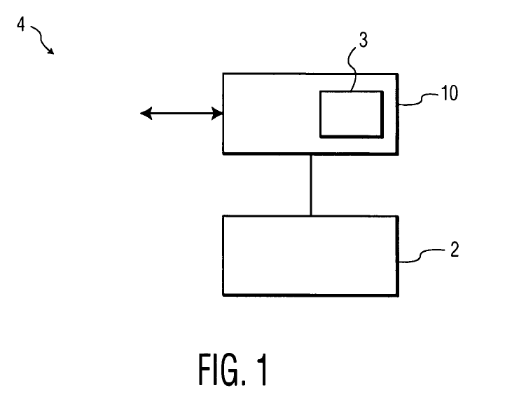

FIG. 1 shows an illustrative system in accordance with an embodiment of the present invention;

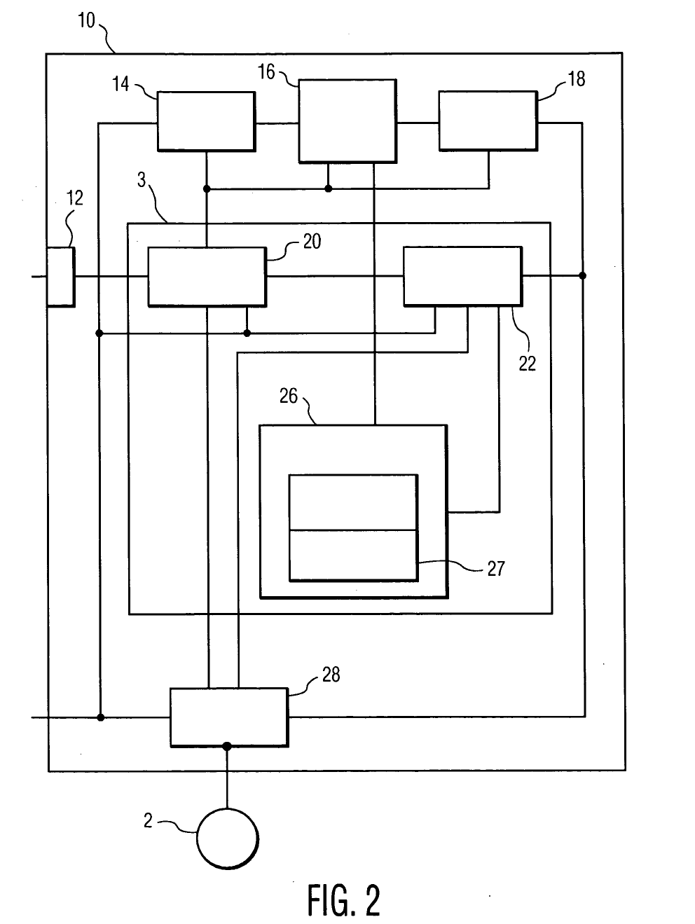

FIG. 2 shows major components of the system according to an embodiment of the present invention; and

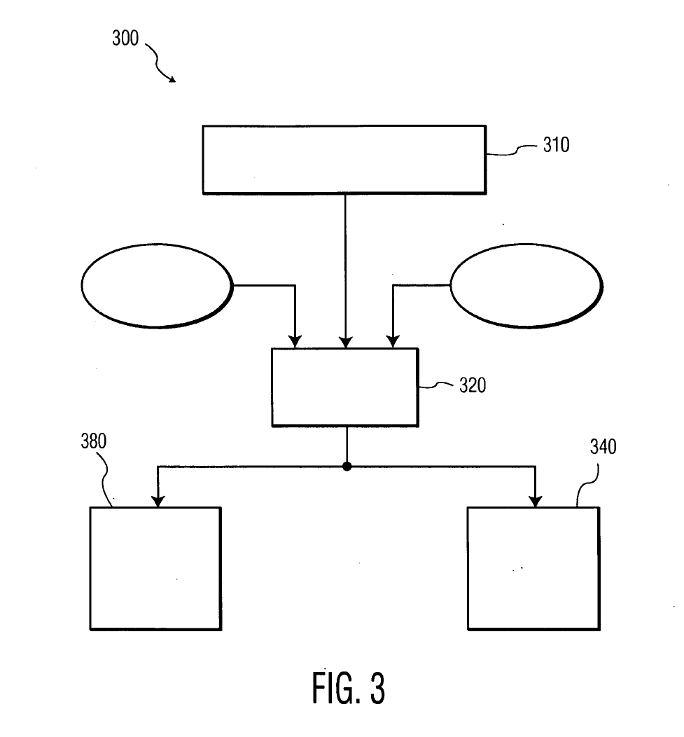

FIG. 3 shows a flow diagram illustrating operation of a system in accordance with an embodiment of the present invention.

The present invention will be described below with reference to an illustrative system for the purposes of facilitating a description. It should not be interpreted as limiting the claims appended thereto. The present inventive system is applicable to numerous alternate embodiments that would readily occur to a person of ordinary skill in the art. The alternate systems should be understood to be encompassed by the appended claims.

FIG. 1 shows a system 4 in accordance with an embodiment of the present invention including a television system 2 and a receiver 10 operationally coupled to the television 2. The receiver 10 includes an automatic subscription sub-system 3. The receiver 10 may also include other personal recording devices, such as ReplayTV™, a TiVo™, and/or other personal video recorder devices that gives the television viewer the ability to capture and manipulate the stream of television shows that are available from cable, satellite, Internet, and other data systems. As shown in FIG. 1, the receiver 10 is configured to receive audio and video programming from the conventional television (TV) broadcast as well as from a variety of other sources, including, for example but without limitation, a cable service provider, digital high definition television (HDTV), digital standard definition television (SDTV), a satellite dish, a conventional RF broadcast, an Internet connection, and/or another storage device, such as a VHS player, a DVD player and other analog and/or digital sources. As would be readily understood by a person of ordinary skill in the art, the services and content provided need not be just television services, but may also include or be music services, data services, or any other known subscription service that is transmitted and/or available in electronic form.

The content may be available to the system 4 in any form including analog, digital, and digitally compressed formats via any delivery means, including satellite, cable, wire, television broadcast, and/or an Internet connection. It should be noted that the present system is also capable of being connected to other possible networks, such as a direct private network, a wireless network, or any other operable link. Any of the above, or other known systems may be suitably utilized in accordance with the present invention.

For the purposes of brevity, each of the above and other known services will be generally referred to as content services, the providers of which will be referred to as content providers, and the data service provided as content. Each of these terms should be understood to encompass any of the above or other types of content and services. In addition, each type of content has ways in which it is observed by a user. For example, music and audio/visual content may be provided to the user in the form of an audible and/or visual signal. Data content may be provided as a visual signal. A user observes different types of content in different ways. For the sake of brevity, the term content consumption is intended to encompass any and all of the known ways in which content is suitably viewed, listened to, etc. by the user.

FIG. 2 illustrates an exemplary receiver 10 in greater detail according to an embodiment of the present invention. The receiver 10 may include a user input 12, such as an infrared (IR) sensor, an encoder 14, such as an MPEG encoder, a content storage device 16, such as a hard disk drive, a decoder 18, a playback section 28, and an automatic subscription sub-system 3. The automatic subscription subsystem 3 is illustratively shown including a controller 20, such as a microprocessor, a program detector 22, and a memory 26. It should be noted that the encoder/decoder may comply with any suitable encoding standards, including MPEG-1, MPEG-2, MPEG-3, MPEG-4, MPEG-7 and/or any other known data encoding/decoding schemes and/or combinations of schemes (e.g., MPEG-2 for audio visual content and MPEG-3 for audio content).

The controller 20 oversees the overall operation of the receiver 10, including a record mode, play mode, and other modes that are common in a personal recording device. During a play mode for example, the controller 20 causes received content to be demodulated and transmitted to the television set 2 for display. During a recording mode, the controller 20 may optionally cause the encoder 14 to receive incoming content and control conversion of the content for storage on the content storage device 16. Thereafter, in response to a user selection via user input 12 and a remote control device (not shown), the controller 20 may cause the content storage device 16 to stream the stored content to the decoder 18 that in turn transmits the decoded content to the television set 2 via the play back section 28 for viewing, listening, etc.

In one embodiment in accordance with the present invention and regarding audio/visual content, audio/video information may be input to a program detector 22 where the content of the audio/video information is analyzed according to a pre-set classification. To this end, a well-known electronic program guide (EPG) protocol may be utilized. An EPG is a standard application designed to aid the viewer in the navigation and selection of broadcast material available in a television broadcast environment. The EPG provides information about each program available and may include programming characteristics, such as the channel number, program title, start time, end time, elapsed time, time remaining, rating, topic, theme, genre, a brief description of the program's content, actors per content, directors, etc.

Using the EPG information or information detectable from the audio/visual content itself, the program detector 22 may classify the incoming programs into one of a group of categories such as genres including sports, classic movies, action movies, etc. By way of example but without limitation, systems for detecting information directly from the audio/visual content are described in U.S. patent application Ser. No. 09/854,511, filed on May 14, 2001, in U.S. patent application Ser. No. 09/846,461, filed on May 1, 2001, in U.S. patent application Ser. No. 09/712,681, filed on Nov. 14, 2000, in U.S. patent application Ser. No. 09/616,631, filed on Jul. 26, 2000, and in U.S. Patent Application Ser. No. 60/561,151, filed on Apr. 9, 2004, each of which is commonly assigned and incorporated by reference as if set out in entirety herein. The analysis outcome by the program detector 22 may then be forwarded and stored in the memory 26 and/or be utilized by the controller 20 directly.

Note that classifying programs according to the content may be performed in a variety of ways. As illustration, prior known systems for classifying programs based on a user profile include, U.S. patent application Ser. No. 09/466,406 filed on Dec. 17, 1999, U.S. patent application Ser. No. 09/627,139 filed on Jul. 27, 2000, U.S. patent application Ser. No. 09/666,401, and U.S. patent application Ser. No. 09/498,271 filed on Feb. 4, 2000, which are commonly assigned and incorporated by reference as if set out in entirety herein.

The program detector 22 may also operate to process and generate data that is representative of habits of a given user, such as a user's viewing history. This data may be utilized by the detector 22 to determine the identity and/or type of programs/channels most watched by the viewer. In this way, the controller 20 may together with the program detector 22 generate a user profile 27 stored in the memory 26 that indicates a user's viewing preferences.

Systems are known that receive input from a user in the form of implicit and/or explicit input about content that a user likes or dislikes. As an example, co-pending, commonly assigned U.S. Pat. No. 6,727,914, filed Dec. 17, 1999, by Gutta et al., entitled, Method and Apparatus for Recommending Television Programming using Decision Trees, incorporated by reference as if set out fully herein, discloses an example of an implicit recommender system. An implicit recommender system recommends content (e.g., television content, audio content, etc.) to a user in response to stored signals indicative of a user's viewing/listening history. For example, a television recommender may recommend television content to a viewer based on other television content that the viewer has selected or not selected for watching. By analyzing viewing habits of a user, the television recommender may determine characteristics of the watched and/or not watched content and then tries to recommend other available content using these determined characteristics. Many different types of mathematical models are utilized to analyze the implicit data received together with a listing of available content, for example from an EPG, to determine what a user may want to watch.

Another type of known television recommender system utilizes an explicit profile to determine what a user may want to watch. An explicit profile works similar to a questionnaire wherein the user typically is prompted by a user interface on a display to answer explicit questions about what types of content the user likes and/or dislikes. Questions may include: what is the genre of content the viewer likes; what actors or producers the viewer likes; whether the viewer likes movies or series; etc. These questions of course may also be more sophisticated as is known in the art. In this way, the explicit television recommender builds a profile of what the viewer explicitly says they like or dislike.

Based on this explicit profile, the explicit recommender will suggest further content that the viewer is likely to also like. For instance, an explicit recommender may receive information that the viewer enjoys John Wayne action movies. From this explicit input together with the EPG information, the recommender may recommend a John Wayne movie that is available for viewing. Of course this is a very simplistic example and as would be readily understood by a person of ordinary skill in the art, much more sophisticated analysis and recommendations may be provided by an explicit recommender/profiling system.

Other recommender systems are known, for example, co-pending, commonly assigned U.S. patent application Ser. No. 09/666,401, filed Sep. 20, 2000, by Kurapati et al., entitled Method and Apparatus for Generating Recommendation Scores Using Implicit and Explicit Viewing, discloses an example of an implicit and explicit recommender system. U.S. patent application Ser. No. 09/627,139, filed Jul. 27, 2000, by Shaffer et al., entitled Three-way Media Recommendation Method and System, discloses an example of an implicit, explicit and feedback based recommender system. U.S. patent application Ser. No. 09/953,385, filed Sep. 10, 2001, by Shaffer et al., entitled Four-Way Recommendation Method and System Including Collaborative Filtering, discloses an example of an implicit, explicit, feedback and collaborative filtering based recommender system. Each of the systems disclosed in the above-noted patent applications are incorporated by reference as if set out fully herein.

In accordance with the present invention, program detector 22 via, for example an EPG, also utilizes information on available subscription services. The program detector may store the information on available subscription services in the memory 26. As utilized herein, a subscription service is any method of providing content to a user on a pay basis. This pay basis may be a pay-per-item basis, such as a pay-per-view system, a pay-per-channel basis, such as Home Box Office (HBO), or any combination of items and channels. This information may include information similar as described above with regard to program EPG data and may include, for example, a description of a subscription service genre.

A system is known that recommends subscriptions to broadcast services based on a viewing history of the user, such as commonly assigned U.S. patent application Ser. No. 09/066,453, filed Dec. 31, 2002, which is incorporated by reference as if set out fully herein. These systems provide suggestions of available broadcast services but still require the user to review these suggestions and render a decision of what subscription service the user desires. Thereafter the user must institute a purchase request to enable delivery of the subscription service. However, with the onslaught of available content, a user may decide to stay with old services or may just not select new services because the process of examining all that is available is so time consuming and cumbersome.

However, in accordance with the present invention and regardless of how the user profile is created and maintained, the automatic subscription sub-system 3 utilizes profile information together with the information on available subscription services to determine what subscription services to subscribe to for the user. In accordance with the present invention, this subscribing to services is performed by the automatic subscription sub-system 3 without user intervention except that a user may specify in advance that a certain monetary limit be respected.

In this way, a user is provided with subscription content without the need of intervention. Accordingly, as subscription services become available, the automatic subscription sub-system 3 may continue to evaluate a users present subscriptions against currently available subscription services to determine whether a different selection of subscriptions is more suitable for the user. This evaluation may be performed periodically to ensure that the user is getting the most out of a determined monetary limit.

Further operation of the present invention will be illustrated with reference to FIG. 3 and previously discussed FIGS. 1 and 2. FIG. 3 shows a flow diagram 300 in accordance with the present invention. Specifically, during act 310 the automatic subscription subsystem 3 receives input from the user designating a criteria for subscription service selection. For example, the criteria for subscription service selection may include a cost limit. This cost limit may represent a total maximum cost of subscription services that the automatic subscription sub-system 3 must respect (e.g., periodically, such as daily, weekly, monthly, annually, etc.) and/or may represent a maximum on a per-item basis, and/or a per-service basis.

An other potential criteria for subscription service selection may be or include, limitations on subscription services that are offered at a given time of the day and/or a particular day of the week. For example, perhaps a user would wish to have subscriptions particularly including Sunday sporting events. The user would then input this criteria during act 310 to preferably or explicitly include this criteria during subsequent acts in accordance with this invention as described more fully herein below. Other potential criteria for subscription service selection may be or include, a critique rating from a professional reviewer/critic, and/or explicit instructions to include other third party input. For example, the user may input criteria to use a collaborative mode wherein profiles from third parties are utilized. In this mode, the controller 20 may retrieve a third party profile from a friend, online service (e.g., compilation of all Yankee™ fans in the New York area), or other collaborative source as the criteria for subscription service selection. Other criteria for subscription selection would readily occur to a person of ordinary skill in the art, including different combinations of these criteria, and therefore these other criteria should be understood to be encompassed by the claims that follow.

Thereafter, during act 320, the automatic subscription subsystem 3 utilizes the data on available subscription services including any available subscription description, the user profile 27, and, for example, a subscription cost limit to select subscription services to subscribe to for the user. This selection may also include a transmission of payment information or authorization to the subscription provider. In accordance with the present invention, a suitable interface exists between the system and the subscription provider to enable the system to autonomously order subscription services.

Act 320 may be performed periodically to ensure that the user's selected subscription services are updated periodically. In some embodiments, the update may be initiated based on a given passage of time, a detected change in user's profile, a detected change in available subscription services, a detected change in the criteria for subscription service selection, such as a change in the limit on subscription service cost, and/or even a detected change in the subscription service cost.

During act 340, the receiver 10 may provide received subscription content to the display 2 or may record the subscription content to the content storage device 16 for later viewing by the user. In this way, the user gets the “best” (the user's subjective perception) content for a given selection criteria (see, act 310). For example, the user is provided with the best content for the money that the user is ready to spend. This content once recorded may be available instantly for playback. The system may also enable full real-time control over the recorded content such as pause, replay, etc.

In operation, the system in accordance with an embodiment of the present invention is given freedom to select and subscribe to subscription services without user supervision or additional user interaction. For example, the system may be allocated a given limited sum of money (e.g., $20 dollars/month) to spend freely. The system manages the subscription services (e.g., subscribe/unsubscribe), downloads content, etc. autonomously, with the goal of maximizing the user interest in the content that can be acquired for a given subscription service selection criteria, such as a limit on the subscription service cost.

In one embodiment, the system may provide the recorded content to the user in the form of a “virtual channel” during act 380. For television content, the result may be a personal television channel where content is recorded based on the user's profile and is presented to the user as a regular television channel (e.g., provided on a given television channel) with optionally, an added benefit of interactivity (e.g., pause, fast forward, instant replay, jump to next scene or episode, etc.), if desired by the user. In this way, the user is provided with a channel selection that always contains content that is of interest.

As an added benefit to the present system, the broadcasters are provided subscription information in a timely manner after content is offered. This may enable the broadcasters to use their broadcasting infrastructure optimally by only continuing to provide content that is of interest (e.g. enough subscription requests received) to the subscribers.

The embodiments of the invention described above are intended for purposes of illustration only, and should not be construed as limiting the appended claims to any particular embodiment or group of embodiments. Numerous alternative embodiments may be devised by those having ordinary skill in the art without departing from the spirit and scope of the following claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for providing a subscription plan to a user, the method comprising the acts of:
receiving data on available subscription services;
receiving a user profile;
receiving subscription service selection criteria from the user; and
determining a subscription service in accordance with the received data, user profile, and selection criteria.

2. The method of claim 1, wherein the selection criteria is a spending limit.

3. The method of claim 2, wherein said spending limit is a maximum spending limit for subscription services for a given period of time.

4. The method of claim 2, wherein the spending limit is a maximum spending limit for any given subscription service and the act of determining the subscription service comprises the acts of:
rating the available subscription services in accordance with the user profile; and
determining a given number of high rated subscription services.

5. The method of claim 1, wherein the act of determining a subscription service comprises the act of periodically determining the subscription service.

6. The method of claim 1, comprising the act of updating the user profile to reflect changes in a user's preference.

7. The method of claim 1, comprising the acts of:
monitoring programs watched by the user;
classifying content of the programs according to a predetermined criteria; and
updating the user profile in accordance with the classified content.

9. The method of claim 1, wherein the act of receiving a spending limit is performed interactively in response to user input.

10. The method of claim 1, further comprising the step of authorizing a debit transaction to a subscription service provider to provide the determined subscription service to the user.

11. The method of claim 1, further comprising the act of storing at least a portion of the determined subscription service in a storage medium for subsequent consumption by the user.

12. The method of claim 11, comprising the act of providing the stored portion of the determined subscription service to the user as a personal television channel.

13. The method of claim 1, wherein the selection criteria is a to utilize a collaborative mode.

14. A device for providing subscription services to a user, the system comprising:
a storage medium configured to store a user profile;
a processor operationally coupled to the memory and configured to receive data on available subscription services and a subscription service selection criteria from the user, and together with the received data and the user profile, the processor is configured to determine a subscription service for the user.

15. The device of claim 14, wherein the processor is configured to determine the subscription service by rating the available subscription services in accordance with the user profile; and selecting a given number of high rated subscription services.

16. The device of claim 14, wherein processor is configured to periodically determine the subscription service for the user.

17. The device of claim 14, wherein the processor is configured to update the user profile to reflect changes in a user's preference.

18. The device of claim 14, wherein the processor is configured to:
monitor a user's content consumption habits;
classify the content according to a predetermined criteria; and
update the user profile in accordance with the classified content and the user's content consumption habits.

19. The device of claim 14, wherein the processor is configured to authorize a debit transaction to a subscription service provider to enable providing the determined subscription service to the user.

20. The device of claim 19, wherein the processor is configured to store at least a portion of the determined subscription service in the storage medium for subsequent consumption by the user.

21. The device of claim 14, wherein the processor is configured to retrieve a portion of the determined subscription service from the storage medium and provide the retrieved portion to the user as a personal television channel.
